(19) United States
(12) Patent Application Publication
(10) Pub. No.: US 2012/0189204 A1
(43) Pub. Date: Jul. 26, 2012

(54) Linking Disparate Content Sources

(76) Inventors: Brian D. Johnson, Portland, OR (US); Michael J. Payne, Beaverton, OR (US); David B. Andersen, Hillsboro, OR (US); Suri B. Medapati, San Jose, CA (US); Michael J. Espig, Newberg, OR (US); Cory J. Booth, Beaverton, OR (US); Kevin J. Murphy, Chandler, AZ (US); Sharad K. Garg, Portland, OR (US); Barry O'Mahony, Banks, OR (US)

(21) Appl. No.: 13/499,008

(22) PCT Filed: Sep. 29, 2009
(86) PCT No.: PCT/US09/58877

§ 371 Date: Mar. 29, 2012

(51) Int. Cl. G06F 17/30; G06F 21/00; G06K 9/00

(52) U.S. Cl. 382/181; 707/769; 707/772; 707/722; 726/16; 707/E17.014; 707/E17.016; 707/E17.002; 707/E17.108; 707/E17.009

(57) ABSTRACT

Digital media content from files, streaming data, broadcast data, optical disks, or other storage devices can be linked to Internet information. Identifiers extracted from the media content can be used to direct Internet searches for more information related to the media content.

### BACKGROUND

This relates generally to digital media such as broadcast, Internet, or other types of content, such as DVD disks.

Conventional media sources of entertainment, such as optical disks, provide rich media that may be played in processor-based systems. These same processor-based systems may also access Internet content. Because of the disparity between the two sources, most users generally view media content, such as broadcast video, DVD movies, and software games independently of Internet-based content.

### BRIEF DESCRIPTION OF THE DRAWINGS

FIG. 1 is a schematic depiction of one embodiment of the present invention;

FIG. 2 is a flow chart for one embodiment of the present invention;

FIG. 3 is a flow chart for another embodiment of the present invention; and

FIG. 4 is a flow chart for still another embodiment of the present invention.

### DETAILED DESCRIPTION

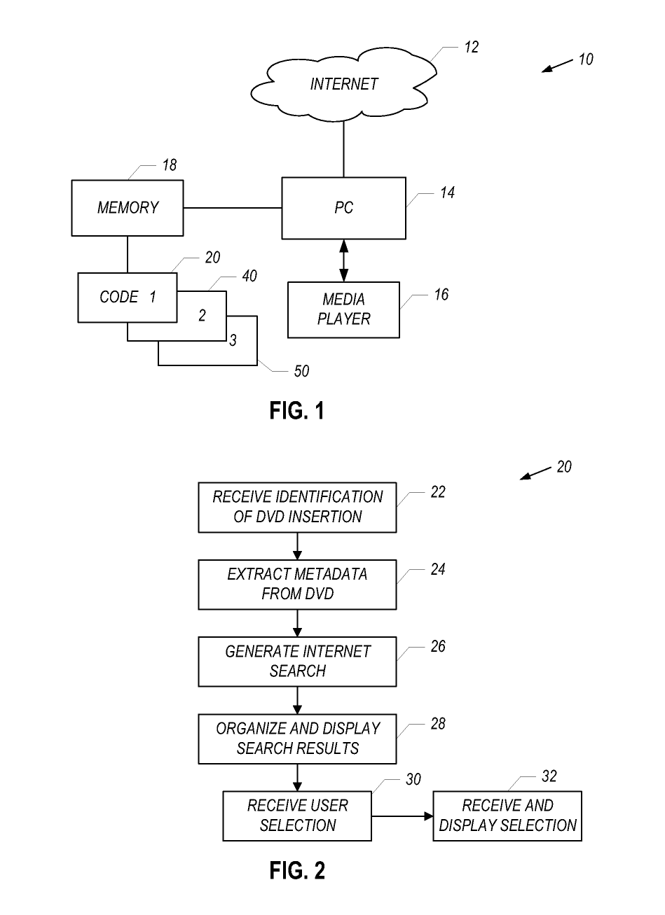

Referring to FIG. 1, system 10 may include a computer 14 coupled to the Internet 12. The computer 14 may be any of a variety of conventional processor-based devices, including a personal computer, a cellular telephone, a set top box, a television, a digital camera, a video camera, or a mobile computer. The computer 14 may be coupled to a media player 16. The media player may be any device that stores and plays media content, such as games, movies, or other information. As examples, the media player 16 may be a magnetic storage device, a semiconductor storage device, or a DVD or Blu-Ray player.

A memory 18, associated with the computer 14, may store various programs 20, 40, and 50, whose purpose is to integrate Internet-based content with media player-based content. The memory 18 may be remote as well, for example, in an embodiment using cloud computing.

Any two content sources may be integrated. For example, broadcast content may be integrated with Internet content. Similarly, content available locally through semiconductor, magnetic, or optical storage may be integrated with Internet content, in accordance with some embodiments.

As one example, consider the situation where the media player 16 is a digital versatile disk player. That player may play DVD or Blu-Ray disks. Generally, such disks are governed by specifications. These specifications dictate the organization of information on the disk and provide for a control data zone (CDZ) that contains information about what is stored on the disk. The control data zone is usually read shortly after an automatic disk discrimination process has been completed. The control data zone, for example, may be contained in the lead in area of a DVD disk. It may include information about the movies or other content stored on the disk. For example, a video manager in the control data zone may include the titles that are available on the disk.

Metadata, such as the information about the titles available on the disk, may be harvested from the disk to locate information on the Internet reasonably pertinent to items displayed based on content stored in the disk. That is, the metadata may be harvested from the control data zone of the disk and used to automatically initiate Internet-based searches for relevant information. That relevant information may be filtered using software to find the most relevant information and to integrate it in a user interface for selection and use by the person who is playing the disk.

The harvested metadata may be metadata available to facilitate location of the content by search engines. As another example, the metadata may be data supplied by a content provider to signal what types of information, including people, topics, subject matter, actors, or locales, as examples, are presented in the content so as to facilitate object location and/or tracking within the content.

For example, the playback of the disk may include an icon that indicates the availability of associated Internet content. An overlay may be provided, in some other cases, to indicate available Internet content. As still another example, a separate display may be utilized to indicate the availability of Internet content. A separate display may, for example, be associated with the computer 14. Thus, the separate display may be the monitor for the computer 14 or may be a remote control for a television system, as another example.

In one embodiment, software may be added to the DVD player software stack that takes DVD metadata and allows the computer to gather information from an Internet protocol connection. The software added to the DVD player's software stack may be part of the stack received from an original equipment manufacturer in one embodiment. In another embodiment, it may be an update that is automatically collected from the Internet in response to a trigger contained on the DVD disk, for example, within the lead in area of the disk. As still another example, the software may be resident in the lead in area of the disk or may be fetched in response to code in the lead in area of the disk.

For example, when a user inserts a DVD disk into an Internet connected player, relevant metadata, such as the title, actors, soundtrack, director, scenes, locations, date, or producers, may be used as key words to search the Internet to obtain material determined to be most relevant to the associated key words. In addition, the user's personal archives may be searched as well. The resulting information may be concatenated in predefined ways to obtain the most pertinent information. For example, the date of the disk may be utilized to filter information about an actor in a movie on the disk in order to get information about the actor most pertinent to the particular movie being played.

The Internet content may be sorted using heuristics or other software-based tools. The resulting search results may be viewed directly from a DVD menu or, alternatively, as a widget that can be viewed while a movie is playing or, as still another example, via another associated interface. The search results that link to content may also be shifted to another device, such as a laptop, phone, or a television for viewing.

The information contained on the disk may be a DVD identifier, such as a serial number, that indicates the content of the DVD and is used to gather metadata from an Internet site or using cloud computing. Instead, the disk may simply include a pointer to a DVD serial number that is then used to gather metadata from outside the disk and outside the DVD player.

As another example, instead of doing the search directly from the user based system 10, the search function may be offloaded to a service provider or a remote server. For example, the extracted metadata may be fed to a service provider that then does the searching, culls the search results, and provides the most meaningful information back to the user. For example, a service like B-D or Blu-Ray disk live may be utilized to conduct the Internet searches based on metadata extracted from the video disk or file.

In some embodiments, instead of using a disk based storage device, metadata may be extracted from a file stored in memory or being streamed or broadcasted to the computer 14. Metadata may be associated with the file in a variety of ways. For example, it may be stored in the header associated with the file. Alternatively, metadata may accompany the file as a separate feed or as separate data.

Similarly, in connection with disks, such as Blu-Ray or DVD disks, the metadata may be provided in one area at the beginning of the disk, such as a control data zone. As another example, the metadata may be spread across the disk in headers associated with sectors across the disk. The metadata may be provided in real time with the playback of the disk, in yet another embodiment, by providing a control channel that includes the metadata associated with the video data stored in an associated data channel.

Referring to FIG. 2, in accordance with one embodiment of the present invention, the coordination of media sources may be implemented using software, hardware, or firmware. In a software embodiment, code 20, in the form of computer executable instructions, may be stored on a computer readable medium, such as the memory 18 (FIG. 1), for execution by a processor within the computer 14. The code 20, shown in FIG. 2, may be implemented by computer readable instructions that are stored in a suitable storage, such as a semiconductor, optical, or magnetic memory. Thus, a computer readable medium may be utilized to store the instructions pending execution by a processor.

The sequence illustrated in FIG. 2 may begin by receiving an identification of content on an inserted DVD or Blu-Ray disk, as indicated in block 22. This identification may include the name of the movie or movies contained on the disk. Metadata from the disk, for example, from the control data zone, may be read. As an example, information about the title, the actors, and other pertinent information stored in the control data zone may be automatically extracted, as indicated in block 24, by software running on the computer 14.

That same software (or different software) may then automatically generate Internet searches using key words obtained from the metadata, as indicated in block 26. The search results may be organized and displayed, as indicated in block 28.

Alternatively, the metadata may be in a control channel on the disk synchronized to a channel containing video data. Thus, the control data may be physically and temporally linked to the video data. That temporally and physically linked control data may include identification metadata for objects currently being displayed from the video data channel.

The search results may be displayed in a user selectable fashion. The user may simply click on or select any of a list of search results, identified by title, and obtained from the Internet, as indicated in block 30. The user selected items may then be displayed, as indicated in block 32. The display may include displaying in a picture-in-picture mode within an existing display, or displaying on a separate display device associated with the display device displaying the DVD content, to mention two examples.

In accordance with some embodiments, information may be extracted from video files. Particularly, information about the identity of persons or objects in those video files may be extracted. This information may then be used to generate Internet searches to obtain more information about the person or object. That information can be additional information about the person or object or can be advertisements associated with displayed objects in the video display that may be of interest to a viewer.

In one embodiment, the displayed objects may be pre-coded within the video. Then, when a user clicks on or touches a screen adjacent that coded video object to select that object to request additional information about the object. Once the object is identified, that identification is then used to guide Internet searching for more information about the identified object or person.

In other embodiments, no such pre-coded identification, within the video data, is provided and, instead, the identification of the object or person is done on the fly in real time. This may be done using video object identification software, as one example.

As still another alternative, a user's system 10 may automatically process the file through a video object identification software tool which pre-identifies the objects in the file and stores information about the identified objects.

In some embodiments, each frame location and each region within the frame may be identified. For example, successive temporal identifiers may be provided to identify one frame from another. These temporal identifiers may run throughout the entire video or may be specific to portions of the video, such as portions between scene changes, portions in the same scene or cut, or portions that include common features. In such cases, the scenes may then be identified temporally as well.

In other cases, each frame may be temporally identified and then location identifiers may be used for regions within the frame. For example, an X, Y grid system may be used to identify coordinates within a frame and these coordinates may then be used to identify and link up objects within the frame with their coordinates and their temporal association with the overall video. With this information, objects can be identified and can even be tracked as they move from frame to frame.

As other examples, object tracking may also be based on unique features within the depiction, such as color (e.g. team uniform color), logos (e.g. product logos, team logos, or team uniforms). In some cases, the selection of objects to be tracked may be automated as well. For example, based on a user's prior activities, objects of interest to that user may be identified and tracked. Alternatively, topics or objects of interest may be identified by social networks independently of that user. Social networks may be instantiated by social networking sites. Then these objects or topics may be identified as search criteria and search results in the form of tracked objects may be automatically fed to members of the social network, for example, by email.

The temporal and location information may be stored as metadata associated with the media content. As one example, a metadata service may be used as described in Section 2.12 of ISO/IEC 13818-1 (Third Edition Oct. 15, 2007) or ITU-T H.222.0 standards (3/2004) Information Technology—Generic Coding of Moving Pictures and Associated Audio Information Systems, Amendments: Transport of AVC Video Data Over ITU-T Rec. H.1220.0/ISO/.EC 13818-1 streams, available from The International Telecommunication Union, Geneva, Switzerland.

Applications may include enabling a user to more easily track an object of interest from scene to scene and frame to frame. Video movie object detection may be done using known temporal differencing or background modeling and subtraction techniques, as two examples. See e.g., C. R. Wren, A. Azarbayejani, T. Darrell, and A. Pentland, “Pfinder: Real-Time Tracking of the Human Body,” IEEE Trans. Pattern Analysis and Machine Intelligence, Vol. 19, No. 7, pp. 780-785, July 1997. Object tracking may involve known model based, region-based, contour-based, and feature-based algorithms. See Hu, W., Tan, T., Wang, L., Maybank S., “A Survey on Visual Surveillance of Object Motion and Behavior,” IEEE Transaction on Systems, Man and Cybermatics, Vol. 34, No. 3, August 2004. This identification of a selected object in subsequent frames or scenes may include using an indicator, such as highlighting, on the identified object.

As another example, this identification can be used to generate searches through other media streams to obtain other content that includes the identified person or object. For example, in some sporting events, there may be multiple camera feeds. The viewer, having selected an object in one feed, may then be shunted to the camera feed that currently includes that identified object of interest. For example, in a golf tournament, there may be many cameras on different holes. But a viewer who is interested in a particular golfer could be shunted from camera to camera feed that currently displays the object or person of interest.

Finally, Internet searches may be implemented based on the identified person or object. These searches may bring back additional information about that object. In some cases, it may pull advertisements related to the person or object that was selected.

In some systems, the selections of objects may be recorded and may be used to guide future searches through content. Thus, if the user has selected a particular object or a particular person, that person may be automatically identified in subsequent content received by the user. An inference or personalization engine may refine searching by building a knowledge database of users' previous activities.

In some cases, it may not be possible to identify an object or user with certainty. For example, a person in the video may not be looking directly at the screen and, thus, facial analysis capabilities may be limited. In such cases, the user can set a confidence level for such identifications. The user can indicate that unless the confidence level is above a certain level, the object should not be identified. Alternatively, the user can be notified of an identification that is based on a level of confidence that is also disclosed to the user.

The object or person identifier is facilitated by Internet searches. Internet searches may be undertaken for similar appearing objects or persons and, once those objects or persons are identified, information related to those Internet depictions may be used to identify them. That is, information associated with similar images on the Internet may then be extracted. This information may be text (e.g. closed caption text) or audio information that may include information that is useful in identifying the object or person.

As another example, where a video file is available and an object of interest has been selected, associated information with the file, such as text or audio, may be searched to identify the selected person or object.

Person identification may also be based on facial or gait recognition. See Hu et al. infra.

In some embodiments, information may be provided from servers or web pages associated with the given media content file. For example, providers of movies or video games may have associated websites that provide information about the objects in the movie or video game. Thus, the first step may be to search such servers or websites associated with the video file being viewed in order to obtain information about the object. For example, an associated website may have information about what the objects are at particular frame positions and particular temporal locations within a video stream. Having obtained that information by matching the user selection in terms of time and frame location to an index contained in a website associated with the video provider, searches can then be undertaken to obtain more information about the object, either through the service provider or independently on the Internet.

The content provider tags may be general in that they refer generally to the entire content of the file. As another example, they may be specific and may be linked to specific objects within the content file. In some cases, objects may be pre-identified by the content provider. In other cases, machine intelligence may be utilized to identify objects in the frame, as described above. As still another example, social networking interfaces may actually suggest objects for identification. Thus, the user's involvement in his social networking site may result in the social networking site being accessed to locate objects that may be of interest, these objects may be identified, and the identification is used by the user.

In addition, the objects that are identified may then be used not only to track the objects within the content file itself, but to locate information external to the content file. Thus, a mash up may link to other sources of information about the identified object. As an example, a user or social network site may select a particular athlete, that athlete may be tracked from scene to scene within the content file, and information about the athlete may be tracked from the Internet, such as statistics or other sources of information.

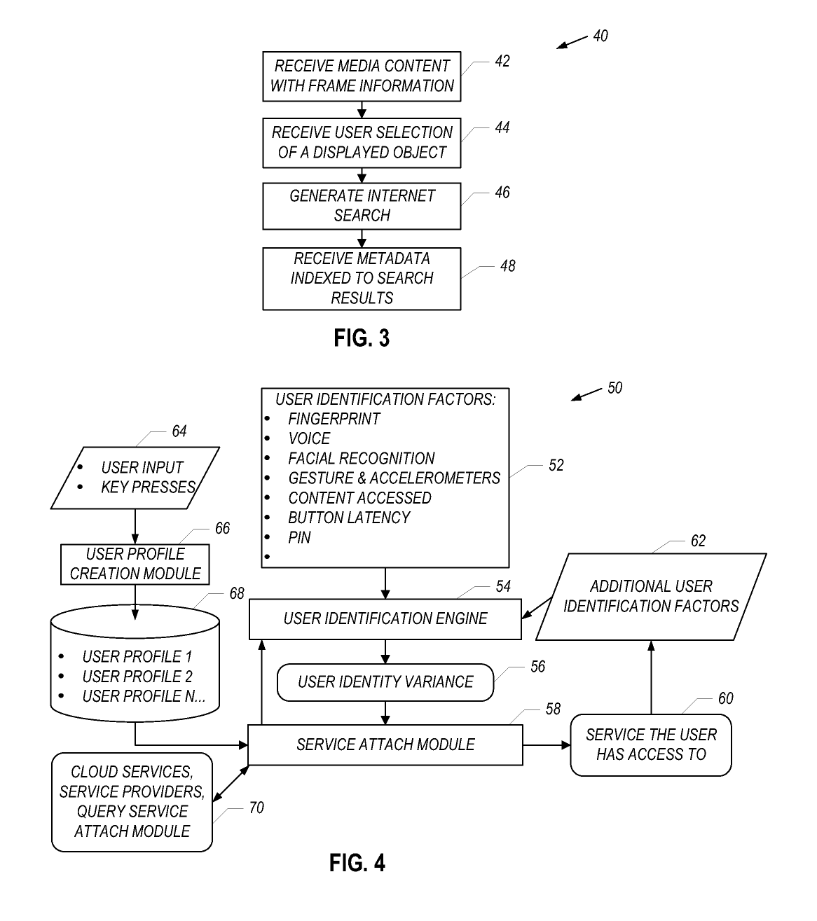

Thus, referring to FIG. 3, a sequence 40 may be implemented in software, hardware, or firmware. In a software embodiment, computer executed instructions may be stored on a computer readable medium, such as the memory 18, which may be a semiconductor, magnetic, or optical memory, as examples. Initially, media content may be received, together with frame information, as indicated in block 42. This frame information may include temporal identification which identifies the frame within a series of video frames, such as a scene or a video file, and may also include information identifying the location of a particular selection within the frame. Then, in block 44, a user selection of a displayed object is obtained, the object may be identified and the object located in subsequent frames using any of the techniques described herein. Thus, in some cases, the object may actually be associated with a name using metadata associated with the file or by implementing computer searches and, in other cases, a characteristic of the identified object is used to guide searches within the ensuing frames of video. As a result, an Internet search may be undertaken to identify the selected object in block 46. Metadata may be indexed to the search results in block 48.

In some cases, these Internet searches may be augmented by identification of the user. One search criteria may be based on user supplied criteria or the user's history of activities on the computer 14. The user may be identified in a variety of different fashions. These user identification functions may be classified as either passive or active. Passive user identification functions identify the user without the user having to take any additional action. These may include facial recognition, voice analysis, fingerprint analysis (where the fingerprint is taken from within a mouse or other input device) habit analysis that identifies a person based on the user's habits, such as the way the user uses a remote control, the way the user acts, the way the user gestures, or the way the user manipulates the mouse. Active user identification may involve the user providing a personal identification number or password or taking some other action in order to assist in identification.

The system may then be able to determine a degree of confidence in its identification. If only passive techniques have been utilized and only some of those techniques have been utilized, the system can assign a degree of confidence score to the user identification.

In many cases, various tasks that may be implemented may be associated with user identifications. For example, more highly secure tasks may require a higher level of confidence of user identification, while common tasks may be facilitated based on the low level of user identification.

For example, if all that is being done, based on the user identification, is to assemble information about the user's interests, a relatively low level of confidence in a user's identification, for example, based only on passive sources, may be sufficient. In contrast, where the access may be to confidential information, such as financial or medical information, a very high level of identification confidence may be desired.

In some cases, by combining numerous sources of identification information, a higher level of confidence may be achieved. For example, a user may steal someone else's password or personal identification number (PIN) and may use the password or PIN number to gain access to a system. But the user may not be able to fool facial identification, voice analysis, or habit sensors that also determine user identity. If all of the sensors confirm an identification, a very high level of certainty may be obtained that the user really is who the user claims to be.

Referring to FIG. 4, a sequence 50 may be implemented in software, hardware, or firmware. In a software embodiment, the sequence may be implemented by computer executed instructions which may be stored in a tangible medium, such as the memory 18. A number of different user identification tools 52 may be available, including fingerprint, voice, facial recognition, gesture, and accelerometer information, content access, button latency, and PIN information. Different identification tools and different combinations of tools may be used in other embodiments. Button latency may be based on how long the user holds a finger on a mouse selection button in various circumstances.

This information may be combined to give relatively low or high levels of user identification by user identification engine 54. That engine also receives an input from additional user identification factors at block 62. The user identification engine 54 communicates with a user identity variance module 56. The engine 54 generates a user identity variance, indicating the level of confidence that the user is in fact one of the user profiles. This module indicates a difference between information needed for perfect identification of a particular user profile and if any information is available. This difference may be useful in providing a level of confidence for any user identification.

A user profile may be tied to content and service time authentication. User profiles can contain, for example, demographics, content preferences, customized content, customized screen elements (e.g. widgets) or non-secure accounts (e.g. social network accounts). The user profile may be created by the user or inferred and created by system 10 to maintain contextual information about the user.

The module 56 is coupled to a service attach module 58. It provides a service to the user and provides information that allows the service to be provided to the user based on access, as indicated in block 60. The service attach module 58 may also be coupled to cloud services, service providers, and a query service attach module, as indicated in 70. The service attach module determines the service level accessible to the user based on the variance identity variance threshold for each service and the user identity variance.

Various user profiles 68 may provide information about different users, in terms of the available identification factors. A user profile creation module 66 may receive user inputs at 64 and may provide further user profile information as those inputs are processed and analyzed to match them up with particular users.

Thus, in some embodiments, simple, unobtrusive techniques may be utilized to identify the user. These techniques may be considered simple and unobtrusive in that they require no extra activity from the user. Examples of such techniques include taking an image of the user, followed by user identification based on the image. Thus, the image that is captured may be compared to a file to determine whether or not the authorized user is the one who is using the device. The image may be captured automatically so it is entirely passive, simple, and unobtrusive. As another example, an accelerometer may detect the person's unique way of using a remote control.

Each of these or other techniques may then be analyzed to determine whether or not the user can be identified and, if so, may give a level of confidence based on the available information. For example, video techniques may not always be perfect because the lighting may be poor or the person may not be facing the video camera accurately. As a result, the application may provide a level of confidence based on the quality of the information received. It may then report this level of confidence.

Then, if the user wants to use a particular application, the level of confidence can be compared to the level of confidence required by the user's requested application, at block 60. If a level of confidence provided by the simple, unobtrusive techniques is not sufficient, a number of alternatives may be resorted to (block 62). As a first example, the user may be asked to provide better information for the unobtrusive techniques. Examples of this include requiring that the user provide more lighting, requiring that the user face the camera, or suggesting that the user focus the camera better. As still another example, the user can be asked to provide input in the form of other user identification techniques, be they passive or active.

Then the identification process iterates using the new information to see if it provides sufficient quality to satisfy the requirements of the requested application. In some embodiments, the suggested techniques for user identification may become ever less unobtrusive. In other words, the user is not bothered except as necessary.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a selection of an object within a video file;
searching for that object within ensuing frames of said video file; and
identifying the presence of that object within an ensuing frame of said video file.

2. The method of claim 1 including using the object identification to attempt to locate additional information about that object outside the video file.

3. The method of claim 2 including implementing Internet searches for an identified object.

4. The method of claim 2 including determining a textual name for said object.

5. The method of claim 4 including determining said textual name by doing image searches and locating text associated with an image search result.

6. The method of claim 5 including receiving an object to search from a social network.

7. The method of claim 1 including using an identification of a user selected object within a video file to mash up with other information about that object.

8. A computer readable medium storing instructions executed by a computer to:
receive a selection of an object within a video file;
search for that object within ensuing frames of said video file; and
identify the presence of that object within an ensuing frame of said video file.

9. The medium of claim 8 further storing instructions to use object identification to locate additional information about that object outside the video file.

10. The medium of claim 9 further storing instructions to implement Internet searches for an identified object.

11. The medium of claim 9 further storing instructions to determine a textual name for said object.

12. The medium of claim 11 further storing instructions to determine said textual name by doing an image search and locating text associated with an image search result.

13. The medium of claim 12 further storing instructions to receive an object to search from a social network.

14. The medium of claim 8 further storing instructions to use an identification of a user selected object within the video file to mash up with other information about that object.

15. A method comprising:
collecting information from digital media content about a characteristic of said content; and
automatically using that information to search the Internet for other information related to the content.

16. The method of claim 15 wherein collecting information includes extracting metadata from an optical disk.

17. The method of claim 15 wherein collecting information includes extracting metadata from a media file.

18. The method of claim 15 wherein collecting information includes extracting data about the media content from a control stream accompanying the media content.

19. The method of claim 15 wherein collecting information includes analyzing the media content to obtain information about the location of objects depicted in the media content.

20. The method of claim 15 including using video content analysis techniques to identify objects within a video stream.

21. The method of claim 20 including identifying frames temporally within a video stream.

22. The method of claim 21 including identifying locations within a frame in order to facilitate the identification of an object depicted in said frame.

23. The method of claim 15 including automatically identifying an object selected by a user within a video depiction and implementing a search for said object on the Internet.

24. The method of claim 15 including identifying a user based on a plurality of criteria, and determining a measure of confidence in said identification.

25. The method of claim 24 including controlling access to resources based on said level of confidence.

26. A computer readable medium storing instructions for execution by a computer to:
locate information from digital media content about a characteristic of said content; and
automatically use that information to search the Internet for additional information.

27. The medium of claim 26 wherein said medium is an optical disk.

28. The medium of claim 26 wherein said disk is a digital versatile disk.

29. The medium of claim 27 wherein said disk is a Blue Ray disk.

30. The medium of claim 26 including instructions to locate information by extracting metadata that includes information about the digital media content.

31. The medium of claim 26 including instructions to locate information by extracting data about the media content from a control stream accompanying the media content.

32. The medium of claim 26 further including instructions to analyze the media content to obtain information about the location of objects depicted in the media content.

33. The medium of claim 26 further storing instructions to use video content analysis to identify objects within a video stream.

34. The medium of claim 33 further storing instructions to identify frames temporally within a video stream.

35. The medium of claim 34 further storing instructions to identify locations within a frame to facilitate the identification of an object depicted in that frame.

36. The medium of claim 26 further storing instructions to automatically identify an object selected by a user within a video depiction and to implement a search for said object on the Internet.

37. The medium of claim 26 further storing instructions to identify a user based on the plurality of criteria and to determine a measure of confidence in said identification.

38. The medium of claim 37 further storing instructions to control access to resources depending on how high is the measure of confidence in said identification.

39. A method comprising:
receiving a digital media content file;
receiving a user selection of a displayed object within said media file; and
automatically generating an Internet search for information about the displayed object.

40. The method of claim 39 including using video content analysis techniques to identify an object within a video stream.

41. The method of claim 40 including receiving a temporal identification that indicates a frame within a video stream.

42. The method of claim 41 including identifying locations within a frame in order to facilitate the identification of an object depicted in said frame.

43. The method of claim 39 including automatically identifying an object selected by a user within a video depiction and automatically implementing a search for said object on the Internet.

44. The method of claim 43 including indexing the search results to an object identified within a video digital media content file.

45. A computer readable medium storing instructions that are executed by a computer to:
receive a digital media content file;
receive a user selection of an object depicted in said media file; and
automatically generate an Internet search for information about the object.

46. The medium of claim 45 further storing instructions to use video content analysis techniques to identify an object within a video stream.

47. The medium of claim 46 further storing instructions to receive a temporal indication of a frame within a video stream.

48. The medium of claim 47 further storing instructions to identify locations within a frame to facilitate the identification of an object depicted in that frame.

49. The medium of claim 45 further storing instructions to identify an object selected by a user within a video depiction and to implement a search for said object from the Internet.

50. The medium of claim 49 further storing instructions to index the search results to an object identified within a video digital media contact file.

51. A method comprising:
using a plurality of techniques to identify a user of a computer; and
determining a measure of confidence in said identification.

52. The method of claim 51 including controlling access to a resource based on said measure of confidence.

53. The method of claim 51 wherein using a plurality of techniques includes using passive and active techniques to identify a user.

54. The method of claim 53 including assigning a confidence measure to each of said techniques and using said confidence measures to determine said measure of confidence in an identification.

55. The method of claim 51 including determining a resource to be accessed and, based on the resource to be accessed, determining a required measure of confidence and comparing said required measure of confidence to said measure of confidence determined from said plurality of techniques to identify a user of a computer.

56. A computer readable medium storing instructions executed by a computer to:
use at least two different identification techniques to identify a user of a computer;
assigned a confidence level to each of said techniques; and
determine a level of confidence in said identification based on said measures of confidence for each of said techniques.

57. The medium of claim 56 further storing instructions to control access to a resource based on said measure of confidence.

58. The medium of claim 56 further storing instructions to use passive and active techniques to identify a user of a computer.

59. The medium of claim 56 further storing instructions to assign a confidence measure to each of said techniques and use said confidence measures to determine said measure of confidence in said identification.

60. The medium of claim 56 further storing instructions to determine a resource to be accessed and, based on the resource to be accessed, determine a required measure of confidence and compare said required measure of confidence to said measure of confidence determined from said plurality of techniques to identify a user of a computer.

61. An apparatus comprising:
a personal computer;
a storage coupled to said personal computer;
a media player coupled to said personal computer; and
said memory storing instructions to enable said computer to collect information from digital media content about a characteristic of said content and automatically use said information to search the Internet for other information related to the content.

62. The apparatus of claim 61, said storage further storing instructions to identify objects within a video stream in said digital media content.

63. The apparatus of claim 61 wherein said storage further stores instructions to identify an object selected by a user within a media file and to automatically generate an Internet search for information about the selected object.

64. The apparatus of claim 61 wherein said storage further stores instructions to use a plurality of different techniques to identify a user of said personal computer and further stores instructions to determine a measure of confidence in said identification.
